(19) United States
(12) Patent Application Publication
(10) Pub. No.: US 2013/0326601 A1
(43) Pub. Date: Dec. 5, 2013

(54) COMMUNICATION SYSTEM

(71) Applicants: Hitoshi Nishikawa, Osaka-shi (JP); Masayuki Fujii, Osaka-shi (JP)

(72) Inventors: Hitoshi Nishikawa, Osaka-shi (JP); Masayuki Fujii, Osaka-shi (JP)

(73) Assignee: SHARP KABUSHIKI KAISHA, Osaka-shi, Osaka (JP)

(21) Appl. No.: 13/876,502

(22) PCT Filed: Jul. 18, 2012
(86) PCT No.: PCT/JP2012/068204

§ 371 Date: Mar. 28, 2013

(30) Foreign Application Priority Data
Dec. 7, 2011 (JP) 2011-267605

(51) Int. Cl. H04L 29/06

(52) U.S. Cl. CPC H04L 63/083
USPC 726/6

(57) ABSTRACT

A content distribution server receives from an information processing device, a first password generated from first data indicating a key and server specific information specific to the server with the use of a predetermined function. Then, the received first password and processing designation information designating processing are transmitted to a terminal. The terminal generates a second password from second data indicating a key matching with the key indicated by the first data and the server specific information obtained from the information processing device, with the use of the function. Then, the first password from the server and the generated second password are checked against each other, and whether or not to perform processing designated by the processing designation information from the server is determined based on a result of checking.

### TECHNICAL FIELD

This invention relates to a communication system and particularly to a communication system including a server and a terminal which communicate with each other through a network.

### BACKGROUND ART

Service to provide data including a command for operating a television through the Web (abbreviation of World Wide Web) has been proposed. A method for avoiding operation of TV (Television) equipment in response to a command from a malignant service provider in making use of such service has been proposed.

For example, in PTD 1 (Japanese Patent Laying-Open No. 2009-118448), a television obtains image data for operation and an electronic signature through a portable telephone terminal and verifies by using a public key, whether or not the electronic signature is an authentic electronic signature for the image data for operation. When it is certified that the electronic signature is authentic, that is, when it is confirmed that the image data for operation has not been tampered, the television controls itself so as to perform processing designated by processing designation information stored in the image data for operation.

In addition, PTD 2 (Japanese Patent Laying-Open No. 2004-15627) proposes a system for remotely controlling an electronic device through a network. In PTD 2, an electronic device communicates with other electronic devices through a network. An electronic device reads identification information from a removable recording medium capable of recording identification information for identifying an electronic device on a network and determines whether or not to permit remote control of other electronic devices based on the identification information.

### CITATION LIST

### Patent Document

PTD 1: Japanese Patent Laying-Open No. 2009-118448

PTD 2: Japanese Patent Laying-Open No. 2004-15627

### SUMMARY OF INVENTION

### Technical Problem

In PTD 2 (Japanese Patent Laying-Open No. 2004-15627), whether or not to permit remote control of other electronic devices is determined simply based on identification information. In contrast, with the method in PTD 1 (Japanese Patent Laying-Open No. 2009-118448), whether or not an electronic signature is authentic is verified by using a public key, and hence the method is advantageous in that a malfunction of a device as a result of performed processing designated by tampered processing designation information can be prevented.

Furthermore, there is a demand for reliable prevention of a malfunction. For example, in the case of the method in PTD 1 (Japanese Patent Laying-Open No. 2009-118448), there has been a desire that a right to perform processing designated by processing designation information be restricted for each service provider which distributes image data for operation including the processing designation information. PTD 1 (Japanese Patent Laying-Open No. 2009-118448) and PTD 2 (Japanese Patent Laying-Open No. 2004-15627), however, cannot meet this desire.

Therefore, an object of the present invention is to provide a communication system capable of restricting a right to perform processing designated by processing designation information for each provider of the processing designation information.

### Solution to Problem

A communication system according to one aspect of this invention includes a server, a terminal, and an information processing device, which communicate with one another through a network.

The server includes a reception unit for receiving from the information processing device, a first password generated from first data indicating a key and server specific information specific to the server by using a predetermined function and a password transmission unit for transmitting the received first password and processing designation information designating processing to the terminal.

The terminal includes a storage portion for storing second data indicating a key matching with the key indicated by the first data obtained from the information processing device, a second password generation unit for generating a second password from the second data in the storage portion and the server specific information by using the function, and a checking unit for checking the first password received from the server and the generated second password against each other, and determines whether or not to perform processing designated by the processing designation information received from the server based on a result of checking.

Preferably, the information processing device generates the first password from the first data and the server specific information by using the function and transmits the generated first password to the server. The terminal receives the second data from the information processing device.

Preferably, in the communication system, the terminal further includes an output portion for outputting information and an information reception unit for receiving from the server, information for accepting a user operation for performing the processing designated by the processing designation information, and the output portion outputs operation information based on the received information when the processing designated by the processing designation information is performed.

Preferably, in the communication system, the output portion of the terminal includes a display portion for displaying an image, the information reception unit receives from the server, image information for displaying an image of an operation portion for accepting the user operation for performing the processing designated by the processing designation information, and the display portion displays the image of the operation portion based on the received image information when the processing designated by the processing designation information is performed.

Preferably, in the communication system, the terminal performs the processing designated by the processing designation information when the result of checking indicates match between the first password and the second password.

Preferably, in the communication system, the processing designated by the processing designation information includes reproduction control processing for controlling a content reproduction unit for reproducing and outputting a content.

Preferably, in the communication system, the terminal further includes a control signal transmission unit for transmitting a control signal to an electrical device having the content reproduction unit, and the control signal represents a signal for controlling the content reproduction unit in accordance with execution of the processing designated by the processing designation information.

Preferably, in the communication system, the electrical device includes a device communication unit for communication through the network, and the control signal includes an address of the server for communicating with the server via the device communication unit.

Preferably, in the communication system, the content reproduction unit reproduces a content distributed from the server.

Preferably, in the communication system, the content indicates time sequence data. The server further includes a reproduction position obtaining unit for obtaining positional information indicating a position in the time sequence of data being reproduced at the time when the content reproduction unit stops reproduction of the content, and distributes the content based on the positional information obtained by the reproduction position obtaining unit.

Preferably, in the communication system, the server includes a first server for transmitting the first password and the processing designation information to the terminal and a second server indicated by the address described above, and the server specific information indicates information specific to the second server.

Preferably, in the communication system, the server specific information is identification information for identifying the server in the network.

According to another aspect of this invention, a terminal in a communication system including a server, the terminal, and an information processing device, which communicate with one another through a network, has the following features.

The server includes a reception unit for receiving from the information processing device, a first password generated from first data indicating a key and server specific information specific to the server by using a predetermined function and a password transmission unit for transmitting the received first password and processing designation information designating processing to the terminal.

The terminal includes an obtaining unit for obtaining from said information processing device, second data indicating a key matching with the key indicated by the first data, a second password generation unit for generating a second password from the obtained second data and the server specific information by using the function, and a checking unit for checking the first password received from the server and the generated second password against each other, and determines whether or not to perform processing designated by the processing designation information received from the server based on a result of checking.

According to another aspect of this invention, a communication method in a communication system including a server, a terminal, and an information processing device, which communicate with one another through a network, includes the steps of, in the server, receiving from the information processing device, a first password generated from first data indicating a key and server specific information specific to the server by using a predetermined function and transmitting the received first password and processing designation information designating processing to the terminal.

The communication method above includes the steps of, in the terminal, storing in a memory, second data indicating a key matching with the key indicated by the first data obtained from the information processing device, generating a second password from the second data in the memory and the server specific information by using the function, checking the first password received from the server and the generated second password against each other, and determining whether or not to perform processing designated by the processing designation information received from the server based on a result of checking.

According to another aspect of this invention, a program for causing a processor of a terminal in a communication system including a server, the terminal, and an information processing device, which communicate with one another through a network, to perform a control method is provided.

The server includes a reception unit for receiving from the information processing device, a first password generated from first data indicating a key and server specific information specific to the server by using a predetermined function and a password transmission unit for transmitting the received first password and processing designation information designating processing to the terminal.

The control method includes the steps of storing in a memory, by a storage portion of the processor, second data indicating a key matching with the key indicated by the first data obtained from the information processing device, generating, by a second password generation unit of the processor, a second password from the second data in the memory and the server specific information by using the function, and checking, by a checking unit of the processor, the first password received from the server and the generated second password against each other, and whether or not to perform processing designated by the processing designation information received from the server is determined based on a result of checking.

According to another aspect of this invention, a computer readable recording medium recording the program described above is provided.

### Advantageous Effects of Invention

According to the present invention, a right to perform processing designated by processing designation information for each provider of the processing designation information can be restricted.

### BRIEF DESCRIPTION OF DRAWINGS

FIG. 1 is a schematic configuration diagram of a communication system according to the present embodiment.

FIG. 2 is a block diagram of a terminal according to the present embodiment.

FIG. 3 is a block diagram of a controlled terminal according to the present embodiment.

FIG. 4 is a block diagram of an information processing device according to the present embodiment.

FIG. 5 is a block diagram of a content distribution server according to the present embodiment.

FIG. 6 is a diagram showing appearance of the terminal according to the present embodiment.

FIG. 7 is a diagram showing appearance of the controlled terminal according to the present embodiment.

FIG. 8 is a functional configuration diagram of the terminal according to the present embodiment.

FIG. 9 is a functional configuration diagram of the controlled terminal according to the present embodiment.

FIG. 10 is a functional configuration diagram of the information processing device according to the present embodiment.

FIG. 11 is a functional configuration diagram of the content distribution server according to the present embodiment.

FIG. 12 is a flowchart of processing in a system according to an embodiment of the present invention.

FIG. 13 is a flowchart of processing in the system according to the embodiment of the present invention.

FIG. 14 is a diagram showing data in a memory portion of the terminal according to the embodiment of the present invention.

FIG. 15 is a diagram showing data in a memory portion of the content distribution server according to the embodiment of the present invention.

FIG. 16 is a diagram showing data in a memory portion of the information processing device according to the embodiment of the present invention.

FIG. 17 is a diagram showing a communication packet according to the embodiment of the present invention.

FIG. 18 is a diagram showing a display screen image example according to the embodiment of the present invention.

FIG. 19 is a diagram showing a display screen image example according to the embodiment of the present invention.

FIG. 20 is a diagram showing a display screen image example according to the embodiment of the present invention.

FIG. 21 is a diagram showing a display screen image example according to the embodiment of the present invention.

FIG. 22 is a diagram showing a display screen image example according to the embodiment of the present invention.

### DESCRIPTION OF EMBODIMENTS

An embodiment of this invention will be described hereinafter with reference to the drawings. It is noted that the same or corresponding elements in the drawings have the same reference characters allotted and description thereof will not be repeated.

Initially, terms used in processing involved with a communication system according to the present embodiment will be described below.

A “content” refers to data of a motion picture, a still image, voice and sound such as music, text such as sentences, a game, an electronic book, a Web (abbreviation of World Wide Web) page, or combination thereof.

An “API (abbreviation of Application Program Interface) command” corresponds to processing designation information designating processing performed by such a processor as a CPU (abbreviation of Central Processing Unit). The processing designation information refers to combination of directions executed by a processor or commands of a function.

“Executing an API command” refers to execution of processing designated by processing designation information of an API command.

A “UI (User Interface)” refers to an operation portion image for displaying graphics, characters, or the like of an operation portion for accepting a user operation for controlling execution of an API command, and display of an operation portion image is controlled by execution of an API command.

A “UI content” includes the UI described above and a corresponding API command.

A “password” refers to a character string of several ten characters including an alphabet and a numeric, for obtaining certification when a user uses a UI.

A “server domain name” refers to information specific to each server computer within a network and more specifically to identification information allocated under predetermined rules.

A “key” refers to a character string constituted of an alphabet, a numeric, a sign, and the like, which is used for generation of a password.

A “user ID (Identifier)” refers to a character string constituted of an alphabet, a numeric, a sign, and the like for identifying a user of the communication system.

A “content ID” refers to a character string constituted of an alphabet, a numeric, a sign, and the like for identifying a content.

A “reproduction stop position” refers to a position in a time sequence of data being reproduced at the time when reproduction of a content is stopped, with a content being defined as time sequence data. Specifically, the reproduction stop position refers to lapse of hour(s), minute(s), second(s), or the like from the beginning at the time when reproduction is stopped in a case where reproduction was started from the beginning of a content. Alternatively, in a case where a content is an electronic book, a reproduction stop position refers to a page number or the like.

“Reproducing a UI content” refers to an operation for decoding a content in a UI content and reproducing the decoded content. Specifically, the decoded content is reproduced by a reproduction player, which is a prescribed program, and output through an output portion (a display portion, an audio output portion).

A “remote controller code” refers to a code expressed with a prescribed bit length (8 bits or 16 bits), and a remote controller code can be obtained by subjecting a received remote controller signal to decoding processing.

A “remote controller signal” is obtained by encoding a remote controller code.

By driving an infrared emission portion in response to an encoded signal, a remote controller signal which is an infrared signal modulated by the remote controller code is transmitted. In addition, the remote controller code can be obtained by receiving the remote controller signal at a light reception portion and demodulating (decoding) the remote controller signal.

<System Configuration>

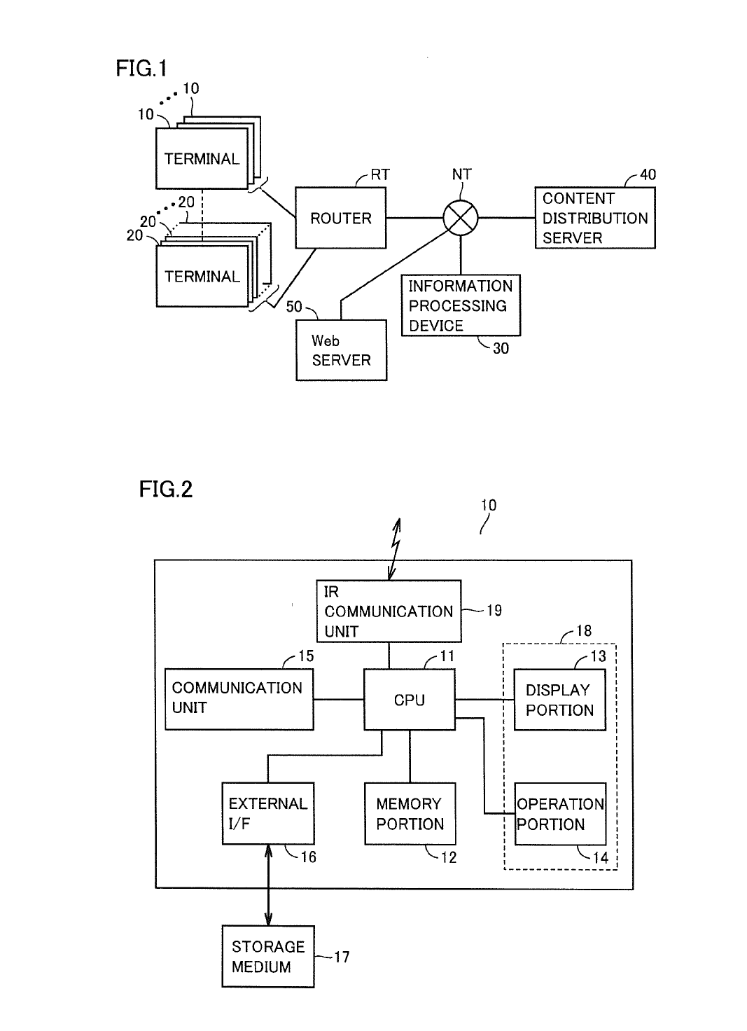

FIG. 1 shows a schematic configuration of the communication system according to the present embodiment. The system includes one or more terminals 10, one or more terminals 20, a content distribution server 40 for distributing a content, an information processing device 30 owned by a seller of terminal 10, and a Web (abbreviation of World Wide Web) server 50. These communicate with one another through various networks NT such as the Internet. Terminal 10 and terminal 20 communicate with each other through a router RT and network NT and also carry out wireless communication through a remote controller signal, or carries out wireless communication through a remote controller signal instead of communication with each other through router RT and network NT.

Terminal 10 communicates with content distribution server 40, information processing device 30 on a side of the seller of terminal 10, and terminal 20 through router RT and network NT. Here, as a form of communication between terminal 10 and terminal 20, IP (abbreviation of Internet Protocol) communication through a LAN (Local Area Network) or near field communication based on infrared communication, Bluetooth™, or the like is applied, however, an applicable form of communication is not limited as such.

It is noted that a communication path between terminal 10 and terminal 20 and a communication path between terminal 10 (or terminal 20) and content distribution server 40, information processing device 30, and Web server 50 may be the same network NT or different networks.

FIG. 2 shows a block configuration of terminal 10. In the present embodiment, a terminal which can be carried by a user, such as a portable telephone, a smartphone, and a tablet terminal, is assumed as terminal 10.

Referring to FIG. 2, terminal 10 includes a CPU (abbreviation of Central Processing Unit) 11, a memory portion 12 including such a storage medium as an HDD (abbreviation of Hard Disc Drive), an SSD (abbreviation of Solid State Drive), a flash memory, a ROM (abbreviation of Read Only Memory), and a RAM (abbreviation of Random Access Memory), a display portion 13 for displaying an image, an operation portion 14 including a button, a key, and the like operated by a user, a communication unit 15, an external I/F (abbreviation of Interface) 16 to which a storage medium 17 is externally removably attached, for reading and writing data from and into attached storage medium 17, and an IR (InfraRed) communication unit 19 for transmitting and receiving a remote controller signal. Terminal 10 includes display portion 13 and operation portion 14 as a touch panel 18 functioning as an integrally configured input and output device.

An LCD (abbreviation of Liquid Crystal Display) display, an organic EL (abbreviation of electroluminescence) display, or the like is applicable as display portion 13. Communication unit 15 has a wired or wireless communication processing function in conformity with such a communication scheme as wired LAN, WiFi (abbreviation of Wireless Fidelity), and 3G (abbreviation of 3rd Generation).

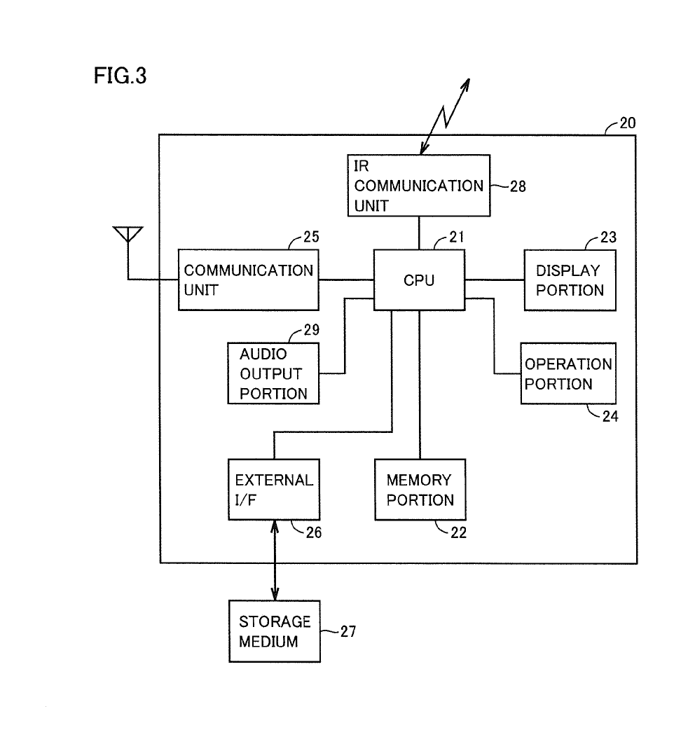

FIG. 3 shows a block configuration of terminal 20. Terminal 20 represents a controlled terminal to be controlled by terminal 10. In the present embodiment, terminal 20 is assumed, for example, as an electrical device (including a television, a smartphone, a tablet terminal, and the like) having a function of communication via network NT and an image output function. Here, it is assumed that an electrical device is a television.

Referring to FIG. 3, terminal 20 includes a CPU 21, a display portion 23 implemented by a liquid crystal display, a memory portion 22 implemented by an HDD, an SSD, a flash memory, a ROM, a RAM, or the like, an operation portion 24 implemented by a button, a key, and the like, a communication unit 25 to which an antenna is connected, for receiving a broadcast signal, an external I/F 26 to which a storage medium 27 is removably attached, for reading and writing data from and into attached storage medium 27, an IR communication unit 28 for transmitting and receiving an infrared signal such as a remote controller signal, and an audio output portion 29 for outputting voice and sound. Though terminal 20 which is a television includes IR communication unit 28 for transmitting and receiving a remote controller signal subjected to infrared modulation to and from an external remote controller, a remote controller signal transmitted and received by terminal 20 is not limited to an infrared signal.

A CD-ROM (Compact Disc Read Only Memory), a memory card (a card-type memory device including a flash memory as a storage medium), or the like can be applied as storage media 17 and 27.

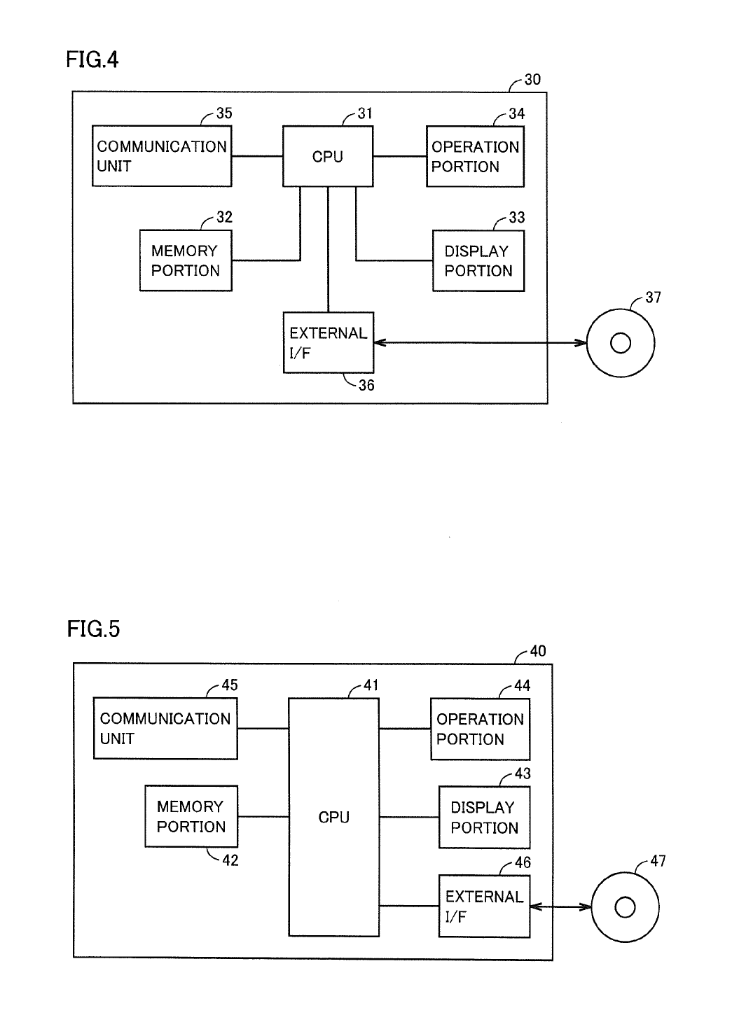

FIG. 4 shows a block diagram of information processing device 30 according to the present embodiment. In the present embodiment, for example, a computer owned by a seller of terminal 10 is assumed as information processing device 30. Information processing device 30 includes a CPU 31, a memory portion 32 implemented by an HDD, an SSD, a ROM, a RAM, a flash memory, or the like, a display portion 33 implemented by an LCD, organic EL, a CRT (Cathode Ray Tube), or the like, an operation portion 34 implemented by a button, a key, a mouse, and the like, a communication unit 35 for communication via network NT, and an external I/F 36 to which such an external storage medium as a CD-ROM (Compact Disc Read Only Memory) 37 is removably attached, for reading and writing data from and into the attached storage medium.

FIG. 5 shows a block diagram of content distribution server 40. Content distribution server 40 includes a CPU 41, a memory portion 42 implemented by an HDD, an SSD, a flash memory, a ROM, a RAM, or the like, a display portion 43 implemented by an LCD, organic EL, a CRT, or the like, an operation portion 44 implemented by a button, a key, a mouse, and the like, a communication unit 45 for communication via network NT, and an external I/F 46 to which such a storage medium as a CD-ROM (Compact Disc Read Only Memory) 47 is externally removably attached, for accessing the attached storage medium. Since Web server 50 also has a configuration the same as that of content distribution server 40 in FIG. 5 in the present embodiment, description will not be repeated.

Thus, content distribution server 40 and Web server 50 correspond to a server computer for distributing a content to a client terminal (terminal 10 or terminal 20 in the case of the present embodiment).

(Appearance)

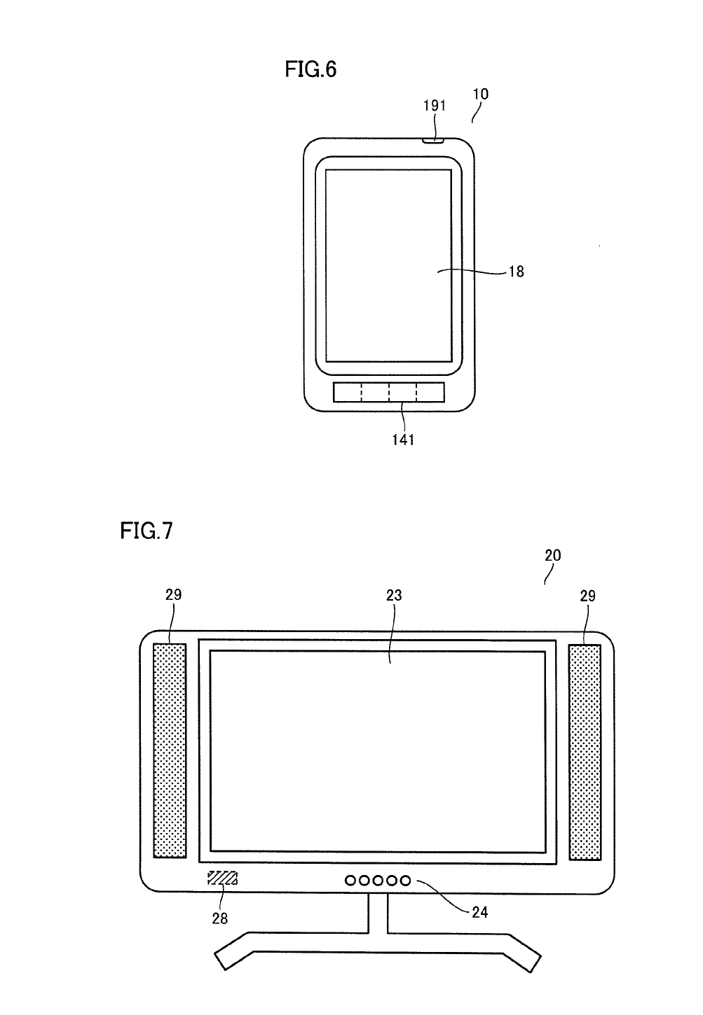

FIG. 6 shows appearance of terminal 10. Referring to FIG. 6, terminal 10 includes touch panel 18 and buttons and keys 141, which are a part of operation portion 14, on a surface of a housing, and includes an infrared ray reception and emission portion 191, which is a part of IR communication unit 19, on a side surface of the housing.

FIG. 7 shows appearance of terminal 20 which is a terminal controlled by terminal 10. Referring to FIG. 7, terminal 20 includes on a surface of a housing, a screen of display portion 23, a speaker corresponding to audio output portion 29, an infrared ray reception and emission portion which is a part of IR communication unit 28, and a button corresponding to operation portion 24 (a power button, a volume button, a channel button, or the like).

It is assumed here that terminal 20 is arranged around terminal 10 and establishes infrared communication, however, in a case where it is connected to network NT, communication through wired LAN, wireless LAN, or Bluetooth™ may be established.

(Functional Configuration)

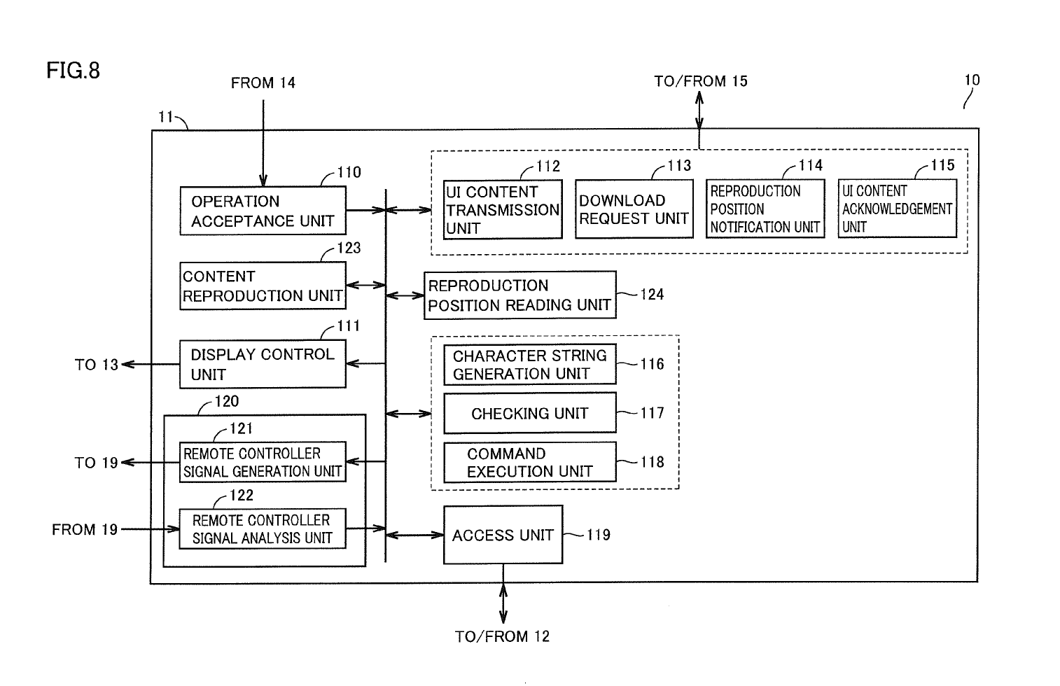

A functional configuration of each device will now be described with reference to FIGS. 8 to 11. FIG. 8 shows a functional configuration included in CPU 11 of terminal 10. CPU 11 includes an operation acceptance unit 110 for accepting a user operation through operation portion 14 and outputting an instruction based on the accepted operation, a display control unit 111 for controlling display portion 13 for display of an image, a UI content transmission unit 112 for transmitting a UI content to terminal 20 through communication unit 15, a download request unit 113 for transmitting a request for downloading a content through communication unit 15, a reproduction position notification unit 114 for notification of a reproduction position of a content through communication unit 15, and a UI content acknowledgement unit 115 for acknowledging a UI content through communication unit 15. Furthermore, terminal 10 includes a character string generation unit 116 for generating a character string which is a password different from a password in the acknowledged UI content, a checking unit 117 for checking the generated character string and the acknowledged password against each other, a command execution unit 118 for executing an API command in the UI content, an access unit 119 for accessing (reading and writing) a program or data in memory portion 12, and a remote controller unit 120. Moreover, CPU 11 includes a content reproduction unit 123 for reproducing a content and a reproduction position obtaining unit 124 for obtaining a reproduction stop position.

Remote controller unit 120 includes a remote controller signal generation unit 121 for generating a remote controller signal based on an input remote controller code and outputting the remote controller signal to IR communication unit 19 and a remote controller signal analysis unit 122 for analyzing the remote controller signal received through IR communication unit 19 and outputting a remote controller code representing a result of analysis.

Though UI content transmission unit 112 is assumed to transmit a UI content through communication unit 15, it may transmit the same through IR communication unit 19.

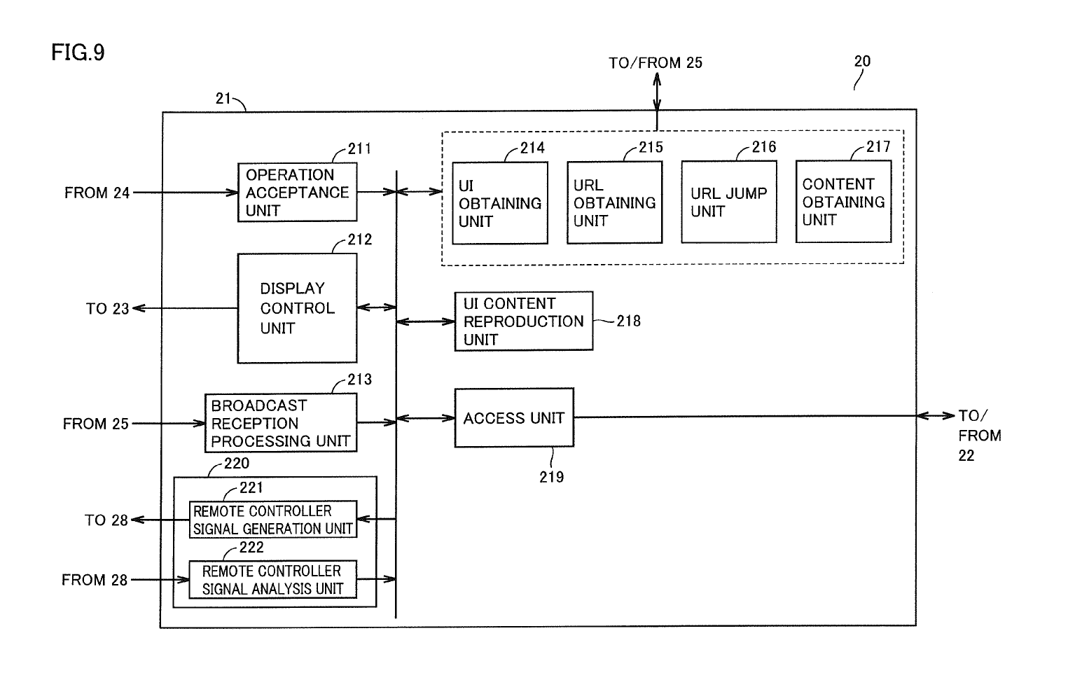

FIG. 9 shows a functional configuration included in CPU 21 of terminal 20 which is a controlled terminal. CPU 21 includes an operation acceptance unit 211 for accepting a user operation through operation portion 24 and outputting an instruction based on the accepted operation, a display control unit 212 for controlling display portion 23 for display of an image, a broadcast reception processing unit 213 for processing a broadcast signal received through an antenna and communication unit 25, a UI obtaining unit 214, a URL (Uniform Resource Locator) obtaining unit 215, a URL jump unit 216, and a content obtaining unit 217. UI obtaining unit 214 extracts a UI from a UI content received through communication unit 25. URL obtaining unit 215 extracts a URL from a UI content received through communication unit 25. URL jump unit 216 transmits a content request to Web server 50 based on a URL. Content obtaining unit 217 extracts a content from a UI content received through communication unit 25.

In addition, terminal 20 includes a UI content reproduction unit 218 for reproducing a UI content, an access unit 219 for accessing a program or data in memory portion 22, and a remote controller unit 220.

Remote controller unit 220 includes a remote controller signal generation unit 221 for generating a remote controller signal based on an input remote controller code and outputting the same to IR communication unit 28 and a remote controller signal analysis unit 222 for analyzing the remote controller signal received through IR communication unit 28 and outputting a remote controller code representing a result of analysis.

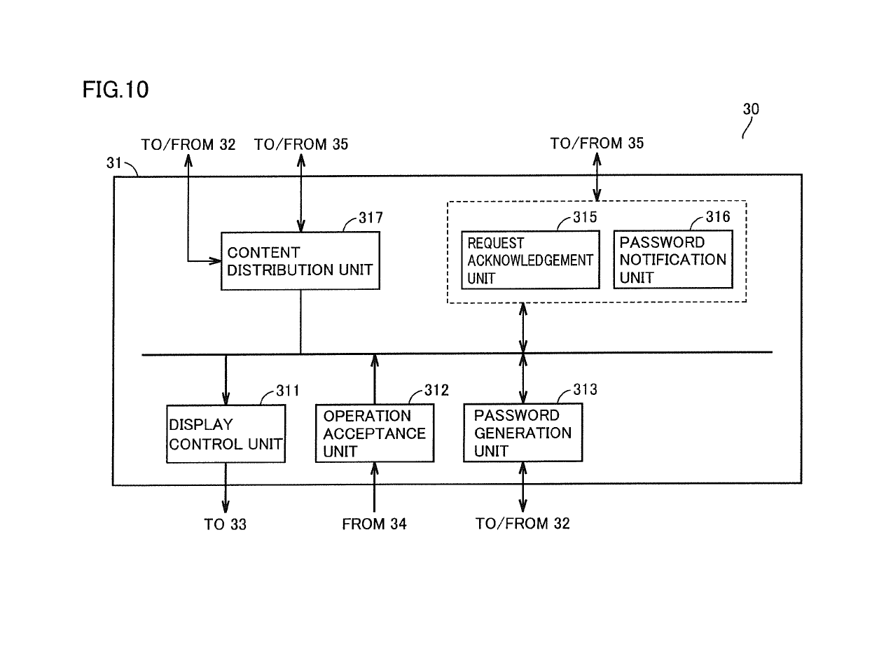

FIG. 10 shows a functional configuration included in CPU 31 of information processing device 30. CPU 31 includes a display control unit 311 for controlling display portion 33, an operation acceptance unit 312 for accepting a user operation through operation portion 34 and outputting an instruction based on the accepted operation, a password generation unit 313, a password notification unit 316 for transmitting a generated password for notification to an external device, and a request acknowledgement unit 315 for accepting a password request.

CPU 31 further includes a content distribution unit 317 for receiving a request for obtaining a content, reading a content from memory portion 32, and transmitting the content to a source of request.

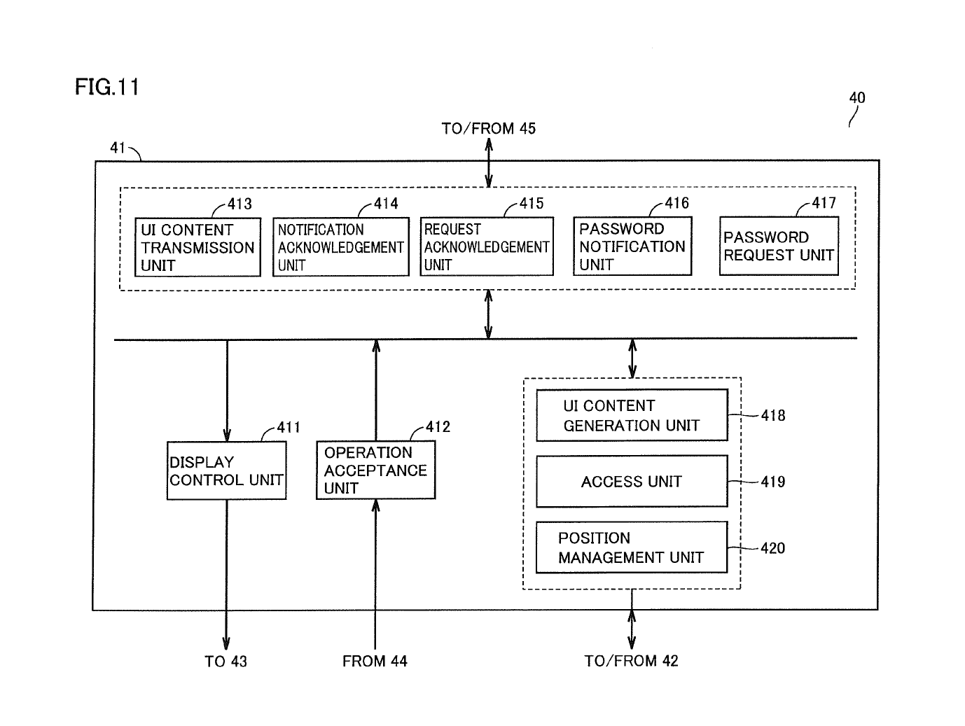

FIG. 11 shows a functional configuration included in CPU 41 of content distribution server 40. CPU 41 includes a display control unit 411 for controlling display portion 43, an operation acceptance unit 412 for accepting a user operation through operation portion 44 and outputting an instruction based on the accepted operation, a UI content transmission unit 413 for transmitting the generated UI content through communication unit 45, a notification acknowledgement unit 414 for acknowledging a notification through communication unit 45, a request acknowledgement unit 415 for acknowledging a request through communication unit 45, a password notification unit 416 for notifying terminal 10 of a password through communication unit 45, and a password request unit 417 for transmitting a password request to information processing device 30 through communication unit 45.

CPU 41 further includes a UI content generation unit 418 for generating a UI content to be distributed, an access unit 419 for accessing (reading and writing) data or a program in memory portion 42, and a position management unit 420.

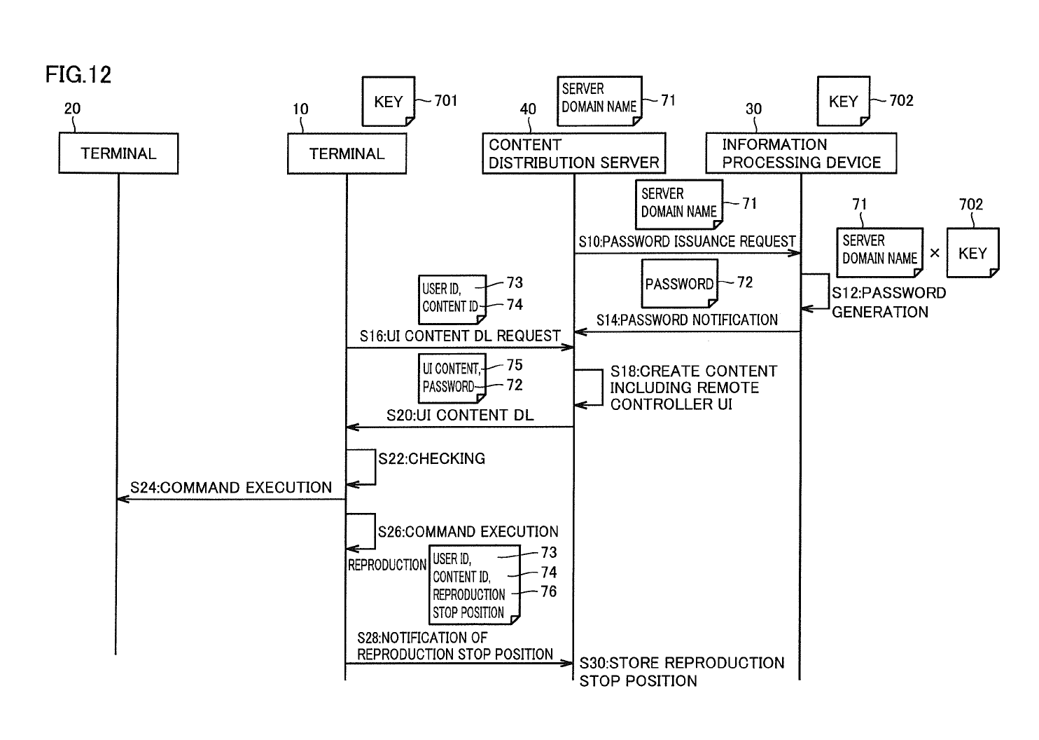

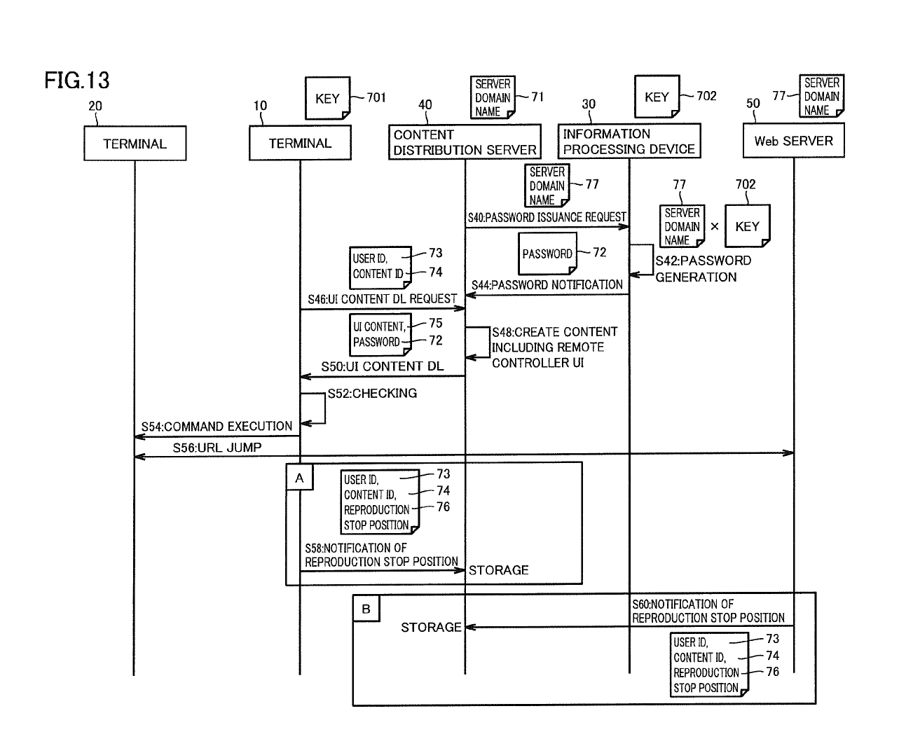

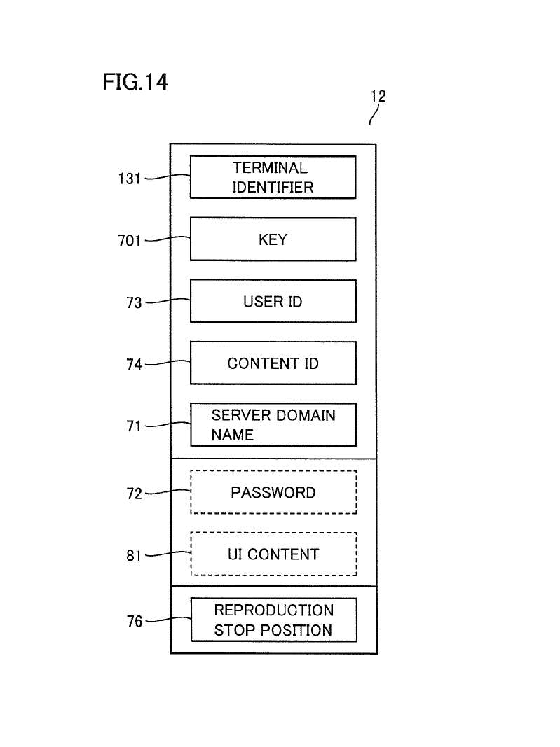

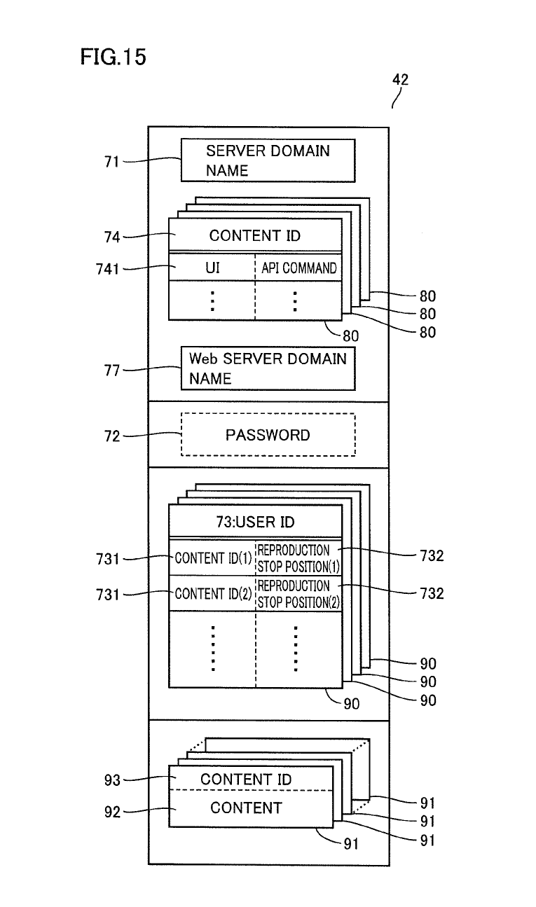

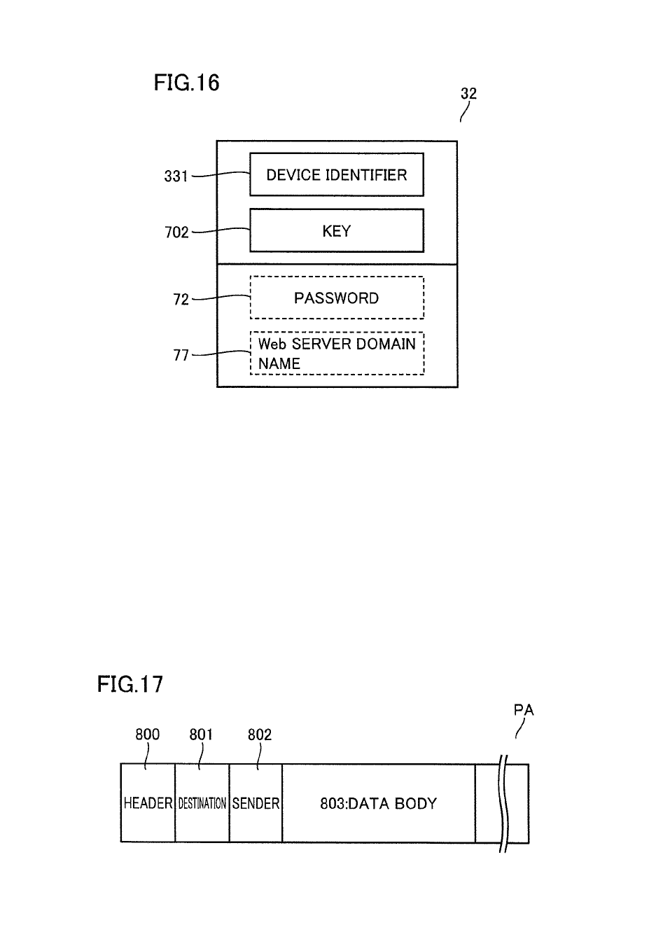

FIGS. 12 and 13 show flowcharts of processing in the system according to the embodiment of the present invention. FIG. 14 shows one example of data stored in memory portion 12 of terminal 10, FIG. 15 shows one example of data stored in memory portion 42 of content distribution server 40, and FIG. 16 shows one example of data stored in memory portion 32 of information processing device 30.

Referring to FIG. 14, memory portion 12 stores a terminal identifier 131 for uniquely identifying terminal 10, a key 701 which is a character string including alphanumerics, signs, and the like, a user ID 73 for identifying a user of terminal 10, a content ID 74 for identifying a content reproduced by terminal 10, and a server domain name 71 of content distribution server 40. In addition, a password 72 generated by terminal 10, a received UI content 81, and data including a reproduction stop position 76 of a content are stored.

Referring to FIG. 15, memory portion 42 stores server domain name 71 of content distribution server 40, content data 91 for each content 92, and a set table 80 corresponding to each content 92. In addition, password 72 received from information processing device 30 and a reproduction position table 90 for each user are stored. Furthermore, a Web server domain name 77 of Web server 50 is stored. Content data 91 includes a content 92 and a content ID 93.

Set table 80 includes content ID 74 of corresponding content 92 and a set 741. Set 741 includes an API command and a UI to which the API command is allocated.

Reproduction position table 90 includes user ID 73 of a corresponding user and further includes a content ID 731 of a content in correspondence with each content distributed to the user and a reproduction stop position 732 of the content. Reproduction stop position 732 indicates a position of the beginning of the content as an initial value. Thereafter, the reproduction stop position is overwritten (updated) with a reproduction stop position obtained each time reproduction is stopped. Therefore, reproduction stop position 732 indicates a most recently registered reproduction stop position 732 in connection with a content having content ID 731.

Referring to FIG. 16, memory portion 32 of information processing device 30 stores a device identifier 331 for uniquely identifying information processing device 30 in the communication system and a key 702 used for generating a password. In addition, generated password 72 and Web server domain name 77 of Web server 50 are stored.

(Communication Packet)

FIG. 17 shows one example of a communication packet PA which is a data packet transmitted and received through network NT.

Referring to FIG. 17, communication packet PA includes header information 800 including type data of communication packet PA, destination information 801 designating a destination of communication packet PA, sender information 802 indicating a sender of communication packet PA, and a data body 803. It is assumed that communication packet PA is transmitted after it is encrypted on a transmission side, and it is decoded on a reception side.

(Communication Procedure)

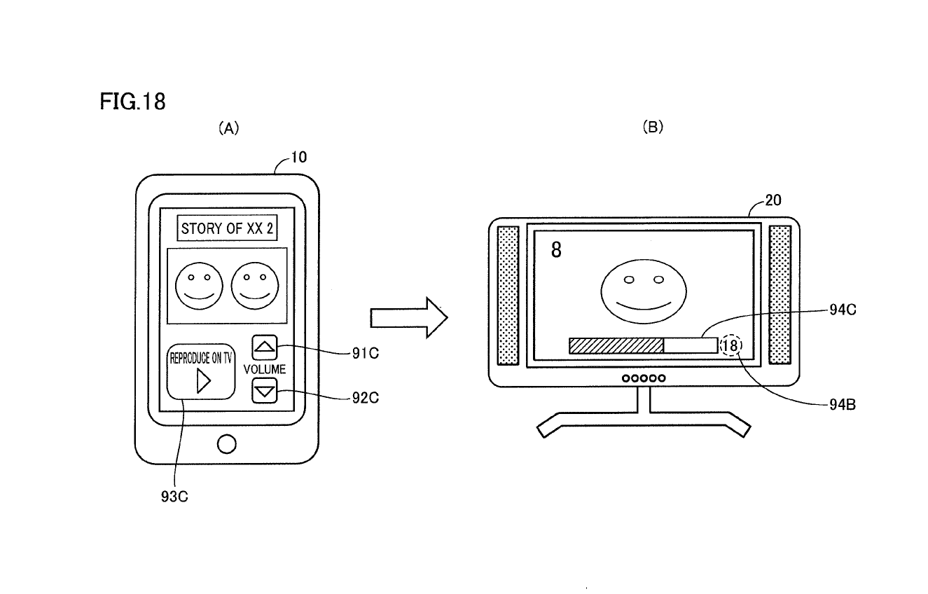

In a communication procedure according to the present embodiment, content distribution server 40 receives from information processing device 30, a first password generated from first data indicating key 702 and server specific information specific to a server distributing a content (for example, a server domain name) with the use of a predetermined function. Then, the received first password and processing designation information designating processing (API command) are transmitted to terminal 10. Terminal 10 obtains in advance from information processing device 30, second data indicating a key matching with key 702 indicated by first data, and generates a second password from the obtained second data and the server specific information, with the use of the function described above. Then, the first password received from the content distribution server and the generated second password are checked against each other, and whether or not to perform processing designated by the processing designation information received from content distribution server 40 is determined based on a result of checking. Details of this processing will be described with reference to FIGS. 18 to 22 based on the communication procedure in FIGS. 12 and 13.

Though the specific information described above is defined as a server domain name in the present embodiment, any data capable of identifying a server on a network may be applicable, and it may be an IP (Internet Protocol) address, a MAC (Media Access Control) address, or the like.

In the present embodiment, in order for terminal 10 to obtain a key in advance, information processing device 30 causes a flash memory representing memory portion 12 of terminal 10 to store key 702 read from memory portion 32 when terminal 10 is sold to a user, or terminal 10 obtains key 702, for example, by receiving key 702 from information processing device 30 through an HP (Home Page) provided by information processing device 30 and storing the key in memory portion 12. It is noted that any method may be adopted as an obtaining method and it is not limited to these methods.

In addition, the HP above has a UI page which is a page of a UI content provided by content distribution server 40. It is assumed that, on a UI page of a desired UI content, a user publishes a server domain name of content distribution server 40 providing the UI content and terminal 10 obtains server domain name 71 of content distribution server 40 providing the desired UI content from the UI page.

Referring to FIG. 12, a user of terminal 10 can request downloading of a UI content in order to reproduce a desired content. Prior to this request for downloading, content distribution server 40 and information processing device 30 generate password 72 through communication. Specifically, password request unit 417 of content distribution server 40 generates and transmits communication packet PA requesting issuance of a password (step S10). In this communication packet PA, type data of header information 800 represents “password request”, destination information 801 represents a device identifier of information processing device 30, sender information 802 represents server domain name 71 read from memory portion 42, and data body 803 represents empty data.

Upon receiving communication packet PA, information processing device 30 generates a password (step S12).

Specifically, communication unit 35 receives communication packet PA, and when it determines that destination information 801 matches with device identifier 331 in memory portion 32, it acknowledges communication packet PA. On the other hand, when it is not the case, communication packet PA is discarded.

In the case of match, communication unit 35 outputs communication packet PA to request acknowledgement unit 315 based on the type data (“password request”) of header information 800 of communication packet PA. Request acknowledgement unit 315 extracts server domain name 71 of destination information 801 from input communication packet PA and outputs the same to password generation unit 313. Password generation unit 313 generates a password from server domain name 71 and key 702 read from memory portion 32, with the use of a predetermined hash function.

Generated password 72 is stored in memory portion 32, and password notification unit 316 uses communication packet PA storing password 72 as data body 803 to notify content distribution server 40, which is a source of request, of the password (step S14). In this communication packet PA, type data of header information 800 represents “password notification”, destination information 801 represents sender information 802 of communication packet PA received in step S10, and sender information 802 represents device identifier 331 read from memory portion 32.

In content distribution server 40, when communication unit 45 receives communication packet PA, it outputs to access unit 419, data body 803 of communication packet PA, based on the fact that the type data of header information 800 indicates “password notification”. Access unit 419 causes memory portion 42 to store the password represented by data body 803 as password 72.

Thereafter, terminal 10 transmits a request for downloading (in the figure, downloading being denoted as “DL”) of a UI content (step S16).

Specifically, the user of terminal 10 inputs a content request including a content ID designating a content by operating operation portion 14. The input content ID is stored in memory portion 12 as content ID 74. Operation acceptance unit 110 outputs a request instruction including the accepted content ID. Download request unit 113 generates communication packet PA requesting downloading of a UI content based on the request instruction and transmits the communication packet through communication unit 15. In this communication packet PA, type data of header information 800 represents a “UI content request,” destination information 801 and sender information 802 represent server domain name 71 and terminal identifier 131 read from memory portion 12, respectively, and data body 803 includes user ID 73 and content ID 74 read from memory portion 12.

Upon receiving communication packet PA requesting downloading of a UI content, content distribution server 40 generates communication packet PA including a UI content (step S18).

Specifically, upon receiving communication packet PA, communication unit 45 outputs communication packet PA to request acknowledgement unit 415 based on the type data of header information 800 “UI content request.” Request acknowledgement unit 415 outputs data body 803 of communication packet PA to UI content generation unit 418 and outputs destination information 801 and sender information 802 to UI content transmission unit 413.

UI content generation unit 418 searches memory portion 42 through access unit 419 based on content ID 74 of data body 803. Based on the result of search, set table 80 including content ID 74 is specified, and a UI content is generated from UI 741 and an API command 742 in specified set table 80. Here, UI 741 includes a plurality of operation portion images and API command 742 includes processing designation information corresponding to each of the operation portion images. UI content generation unit 418 generates a UI content 75 by allocating corresponding processing designation information to each of the operation portion images of UI 741.

UI content transmission unit 413 generates communication packet PA storing as data body 803, generated UI content 75 and password 72 read from memory portion 42, and transmits the communication packet through communication unit 45 (step S20). UI content transmission unit 413 sets the “UI content” as the type data of header information 800 of this communication packet PA, and sets sender information 802 and destination information 801 input from request acknowledgement unit 415 as destination information 801 and sender information 802, respectively.

It is noted that UI content generation unit 418 searches reproduction position table 90 in memory portion 42 through access unit 419 based on user ID 73 and content ID 74 in data body 803. When reproduction position table 90 having user ID 73 and content ID 731 indicating a character string matching with a character string of user ID 73 and content ID 74, in which reproduction stop position 732 corresponding to content ID 731 indicates a value which is not an initial value, is specified based on the result of search, there may also be a case where a UI content is generated by using specified reproduction position table 90. It is assumed here that pertinent reproduction position table 90 could not be specified. Details in the case where a reproduction position table is specified will be described later in “other methods of generating UI content.”

Content distribution server 40 downloads UI content 75 including generated password 72 to terminal 10 which is a source of request (step S20).

Terminal 10 performs processing for authenticating content distribution server 40 (step S22).

Specifically, communication unit 15 receives communication packet PA and outputs destination information 801 and sender information 802 to reproduction position notification unit 114 based on the fact that the type data indicates the “UI content”. In addition, password 72 of data body 803 is output to checking unit 117, UI content 75 is output to command execution unit 118, and character string generation unit 116 is started up. Character string generation unit 116 generates a password from key 701 and server domain name 71 read from memory portion 12 through access unit 119 with the use of a predetermined hash function and outputs the password to checking unit 117. Checking unit 117 checks the received password and the generated password against each other and outputs the result of checking to command execution unit 118.

It is assumed here that information processing device 30 supplies also information on a hash function together with key 701 at the time when it supplies key 701 to terminal 10. Therefore, the hash function used by checking unit 117 for password generation matches with a hash function used by information processing device 30 for password generation.

When command execution unit 118 determines that the result of checking indicates match between the passwords, it executes an API command of UI content 75 (step S24).

As the API command is executed, command execution unit 118 outputs a direction to display an operation portion image of a UI to display control unit 111. Display control unit 111 controls display portion 13 such that it displays an operation portion image in accordance with the direction. FIG. 18 shows a display example. It is noted that content distribution server 40 reads content 92 corresponding to UI content 75 from memory portion 42 and streams the content to terminal 10.

In FIG. 18 (A), on display portion 13, icons 91C, 92C, and 93C which are operation portion images represented by buttons are displayed over a title screen image of content 92. Icon 93C is an operation button for indicating start/stop of reproduction of a content and icons 91C and 92C are operation buttons for adjusting volume. As an operation for starting reproduction is performed, an API command outputs a direction for content transmission based on the operation. Based on the direction, terminal 10 transfers the content distributed to terminal 10 to terminal 20. Thus, as shown in FIG. 18 (B), an image of the content is displayed on a television screen.

In this case, as the operation portion image displayed based on UI content 75 is operated, terminal 10 can be made use of as a remote controller which issues various directions (for example, directions for controlling a state of operation of a television such as start-up of a content on the television, start/end of content reproduction, stop of reproduction, volume adjustment, adjustment of the screen (brightness adjustment), power ON/OFF of the television, timer adjustment of the television, control of a reception channel of the content, and the like), based on the operation.

Specifically, when the user operates icons 91C, 92C, and 93C, operation acceptance unit 110 accepts the operation and outputs an instruction in accordance with the accepted operation. Remote controller signal generation unit 121 receives the signal as a remote controller code and outputs a remote controller signal for controlling the television to terminal 20. Terminal 20 receives the remote controller signal, analyzes the remote controller signal in remote controller signal analysis unit 222, and outputs a remote controller code based on the result of analysis. Content reproduction unit 218 controls reproduction and output of a content in accordance with the remote controller code. In addition, output volume is controlled based on the remote controller code. In FIG. 18 (B), display control unit 212 causes the screen of display portion 23 to display graphics of an indicator 94C indicating volume varying in coordination with the operation of icons 91 C and 92C. In addition, data 94B for indicating volume in a numeric value is shown in association with indicator 94C.

Step S24 described above has been directed to a case where an API command for controlling a television is allocated to an operation portion image of a UI. When an API command for controlling terminal 10 is allocated, however, transition to processing in step S26 is made.

When icons 91C, 92C, and 93C representing the operation portion images on display portion 13 are operated, content reproduction unit 123 controls reproduction of a content on display portion 13 in accordance with an instruction based on the operation accepted by operation acceptance unit 110 (step S26).

When operation portion 14 or icon 93C is operated during reproduction of a content and stop of reproduction is instructed through operation acceptance unit 110, reproduction position obtaining unit 124 obtains a reproduction stop position in response to the instruction and outputs the reproduction stop position to reproduction position notification unit 114. Here, the content is time sequence data, and the time sequence data is distributed as being divided into a unit having a prescribed size. Each piece of unit data includes positional data in accordance with a time sequence (page number, lapse of time from the beginning to the unit data in a case where reproduction is carried out from the beginning of a content, and the like). When stop of reproduction is instructed, reproduction position obtaining unit 124 obtains the reproduction stop position by extracting positional data from the unit data being reproduced and causes memory portion 12 to store the reproduction stop position as reproduction stop position 76.

In order to notify content distribution server 40 of the reproduction stop position, reproduction position notification unit 114 generates and transmits communication packet PA (step S28). In this communication packet PA, data body 803 represents user ID 73, content ID 74, and reproduction stop position 76 read from memory portion 12, type data of header information 800 represents “position notification”, destination information 801 represents server domain name 71, and sender information 802 represents terminal identifier 131.

Content distribution server 40 receives communication packet PA transmitted in step S28, and position management unit 420 causes reproduction position table 90 to store data body 803 through access unit 419 (step S30).

Specifically, reproduction position table 90 is searched based on user ID 73 and content ID 74 in data body 803. Based on the result of search, reproduction position table 90 having user ID 73 is specified, and reproduction stop position 732 corresponding to content ID 731 indicating a character string matching with a character string of the content ID in specified reproduction position table 90 is overwritten with reproduction stop position 76 in data body 803.

(Other Methods of Generating UI Content)

In step S18, UI content generation unit 418 specifies reproduction position table 90 having user ID 73 and content ID 731 indicating a character string matching with a character string indicated by user ID 73 and content ID 74 based on the result of search of reproduction position table 90, and when it determines that reproduction stop position 732 corresponding to that content ID 731 does not have the initial value, it generates UI content 75 by using content ID 731 and reproduction stop position 732 in specified reproduction position table 90.

Specifically, UI content generation unit 418 searches set table 80 having content ID 74 matching with content ID 731 based on content ID 731, and reads a set of UI 741 and API command 742 from searched set table 80. Then, such an API command that an operation portion image for instructing start of reproduction of a content is displayed from most recently registered reproduction stop position 732 is generated from API command 742 in the read set. UI content 75 is generated from the generated new API command and UI 741. Therefore, in the case where reproduction of a content which has been reproduced and viewed on terminal 10 on the go is stopped, as the generated new API command is executed in subsequent step S24 and step S26, reproduction of the content can subsequently be resumed from the most recent reproduction stop position on the television of terminal 20 at home. In contrast, reproduction of a content which has been reproduced and viewed on the television of terminal 20 at home can also be resumed from the most recent reproduction stop position by subsequently using terminal 10 on the go.

In this case as well, the passwords are checked against each other in step S22. Therefore, in terminal 10 and terminal 20, only an API command of a UI content from certified content distribution server 40 is executed.

Timing of transmission of a password issuance request from content distribution server 40 to information processing device 30 in step S10 in FIG. 12 will be described here. So long as a request for issuing a password is performed only once when a content distributor of content distribution server 40 creates a UI page and the same server domain name 71 is used, the request for issuing a password is not made.

According to such a flowchart in FIG. 12, in a case where a UI content provides a remote controller function for controlling terminal 20, terminal 10 can restrict content distribution server 40 providing the remote controller function to terminal 10 and exclude malignant content distribution server 40.

FIG. 13 shows a variation of the flowchart in FIG. 12. Though content distribution server 40 distributes both of a UI content and a corresponding content for reproduction in FIG. 12, different servers may distribute a UI content and a content for reproduction as in FIG. 13. In FIG. 13, content distribution server 40 distributes a UI content, whereas Web server 50 distributes a content for reproduction corresponding to the UI content.

In FIG. 13, terminal 10 and information processing device 30 have key 701 and key 702 matching with key 701, respectively, and content distribution server 40 stores in advance Web server domain name 77 of Web server 50 distributing a content for reproduction.

Here, processing in FIG. 12 is compared with processing in FIG. 13. Processing in steps S40, S42, S44, S46, S48, S50, and S52 in FIG. 13 is compared with processing in S10 to S22 in FIG. 12, and difference therebetween resides in that, in steps S10 to S22, a key and a server domain name of content distribution server 40 are used for generation of passwords to be checked, whereas in steps S40 to S52, a key and server domain name 77 of Web server 50 are used therefor. Since other processing is the same as the processing in steps S10 to S22, description will not be repeated.

After the processing in steps S40 to S52 in FIG. 13 is performed, when it is determined that the result of checking indicates match between the passwords, command execution unit 118 of terminal 10 executes an API command of UI content 75 (step S54).

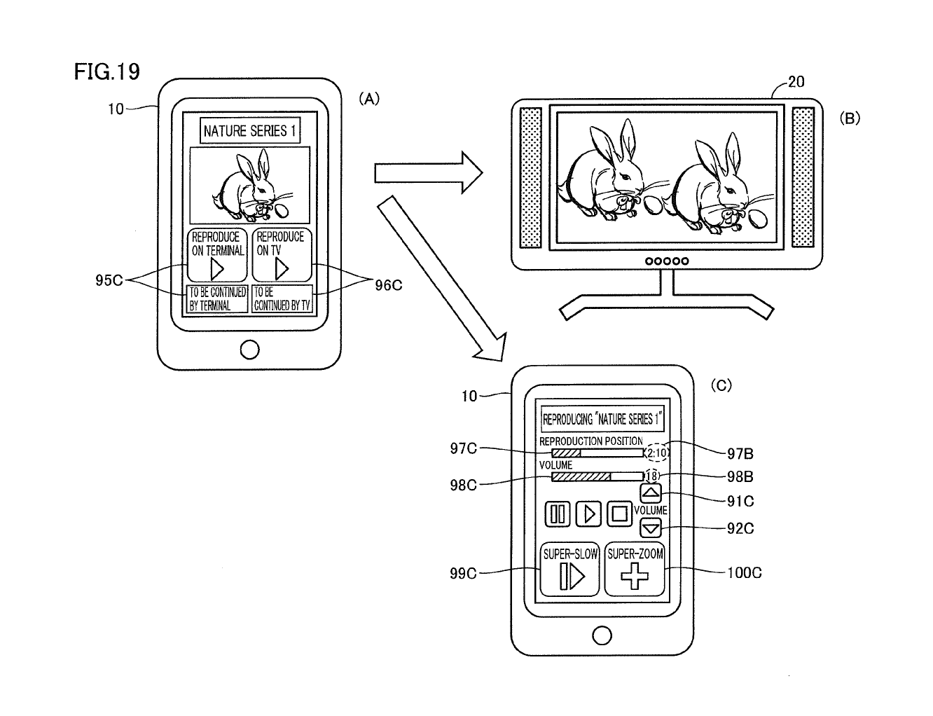

As the API command is executed, command execution unit 118 outputs a direction to display an operation portion image of a UI to display control unit 111. In response to the direction, display control unit 111 controls display portion 13 to display the operation portion image. FIG. 19 shows a display example.

FIG. 19 (A) shows a display screen image of terminal 10, FIG. 19 (B) shows a display screen image of terminal 20, and FIG. 19 (C) shows another display screen image of terminal 10.

FIG. 19 (A) shows a screen image at the time when execution of an API command is started in terminal 10. On the screen, icons 95C and 96C which are operation portion images displayed as a result of execution of an API command are displayed over a title image of a content. Icon 95C is operated when the content is reproduced (including also reproduction from a reproduction stop position) on terminal 10, and icon 96C is operated when a content is reproduced (including also reproduction from a reproduction stop position) on the television of terminal 20.

When icon 96C is operated, a remote controller signal indicating start of reproduction, which includes “content ID and Web server name,” is transmitted from terminal 10 to terminal 20. When terminal 20 receives the remote controller signal, remote controller signal analysis unit 222 analyzes the remote controller signal and outputs the result of analysis to URL obtaining unit 215. URL obtaining unit 215 extracts a URL in accordance with the Web server name from the result of analysis and outputs the extracted URL to URL jump unit 216.

URL jump unit 216 requests Web server 50 to distribute a content based on the URL (step S56). In response to the request, Web server 50 streams the content having the content ID to terminal 20. In terminal 20, content obtaining unit 217 receives the distributed content and outputs the content to content reproduction unit 218. Content reproduction unit 218 reproduces the received content and display control unit 212 causes display portion 23 to display the content (see FIG. 19 (B)).

When icon 95C is operated, terminal 10 requests Web server 50 to distribute a content in accordance with a Web server name and receives stream of a content having the content ID from Web server 50 for display.

In a case where icon 96C is operated and terminal 20 reproduces and outputs a content as in FIG. 19 (B), terminal 10 functions as a remote controller for the television of terminal 20 (see FIG. 19 (C)). Specifically, as an API command is executed, icons 91C, 92C, 99C, and 100C and indicators 97C and 98C which are operation portion images for accepting a remote controller operation are displayed.

Indicator 97C indicates a current reproduction position of a content. A reproduction position is indicated by positional data of each piece of unit data streamed to terminal 20. Specifically, content reproduction unit 218 of terminal 20 extracts positional data from the unit data and outputs the positional data to remote controller signal generation unit 221. Remote controller signal generation unit 221 transmits a remote controller signal indicating the positional data to terminal 10. Remote controller signal analysis unit 122 of terminal 10 analyzes the received remote controller signal. CPU 11 causes display portion 13 to display indicator 97C based on the result of analysis by means of display control unit 111.

Indicator 98C is displayed to show current output volume in coordination with an operation of icons 91C and 92C for adjusting volume of the television.

In addition, data 97B representing a total reproduction time period of a content is displayed in association with indicator 97C, and data 98B representing the volume with a numeric value is displayed in association with indicator 98C.

Icons 99C and 100C are buttons operated in order to designate a characteristic manner of output for each content, and for example, characteristic manners of output include super-slow reproduction, super-zoom reproduction, and the like.

Even in a case of reproduction of a content of Web server 50 in FIG. 19, content distribution server 40 can manage reproduction stop position 732 and carry out reproduction from the reproduction stop position.

Though content distribution server 40 receives the reproduction stop position from terminal 10 as shown with processing A in FIG. 13 in a case where terminal 10 reproduces a content (step S58), it receives the reproduction stop position from Web server 50 as shown with processing B in FIG. 13 in a case of reproduction on the television of terminal 20 (step S60). Namely, when an operation to stop reproduction of a content is performed on the television, terminal 20 transmits to Web server 50, a distribution stop request including a content ID and a user ID stored in advance in memory portion 22. When Web server 50 receives the distribution stop request, Web server 50 stops distribution and transmits to content distribution server 40, positional data of last distributed unit data as the reproduction stop position, together with the user ID and the content ID. Content distribution server 40 manages the reproduction stop position received from terminal 10 or Web server 50 with the use of reproduction position table 90.

According to such a flowchart in FIG. 13, terminal 10 is provided with a remote controller function for controlling terminal 20 based on a UI content. In a case of jumping to Web server 50 indicated by a designated URL as a result of remote control of terminal 20, Web server 50 which is a jump destination can be restricted. Thus, malignant Web server 50 can be excluded.

It is noted that password checking may be required/may not be required depending on a function implemented by execution of an API command allocated to a UT (icons 95C, 96C, and the like).

(Reproduction of Other Contents)

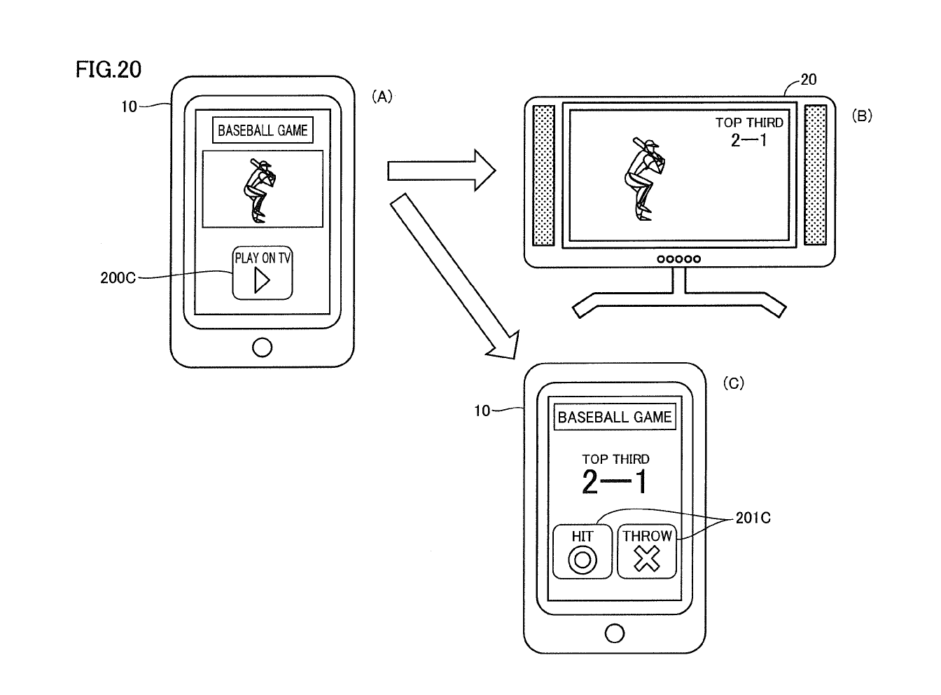

A content distributed from Web server 50 may be a game content. FIG. 20 (A) shows a title image of a game on terminal 10 and an icon 200C which is an operation portion image for starting the game is displayed over the title image. When icon 200C is operated, a remote controller signal instructing start of the game is transmitted to terminal 20. In response to the instruction to start the game, in accordance with a procedure for obtaining a content described above, a game content is distributed from Web server 50 to terminal 20 and an image of the distributed game content is displayed on display portion 23 (see FIG. 20 (B)). When icon 200C is operated, icon 200C displays an icon 201C which is an operation portion image of a game console (see FIG. 20 (C)). When icon 201C is operated, a remote controller signal based on the operation is transmitted to terminal 20 so that the game can proceed. Thus, terminal 10 functions as a controller for the game console.

It is noted that, even in a case where a content is a game, in accordance with the procedure the same as described above, content distribution server 40 can re-start the game from a reproduction stop position by managing the reproduction stop position received from terminal 10 or Web server 50 based on reproduction position table 90.

A content distributed to terminal 10 in accordance with the procedure in FIG. 12 or FIG. 13 may be a content of an electronic book. Terminal 10 receives a content of an electronic book from Web server 50 and memory portion 12 stores the content. Terminal 10 functions as a terminal for viewing an electronic book as an API command is executed.

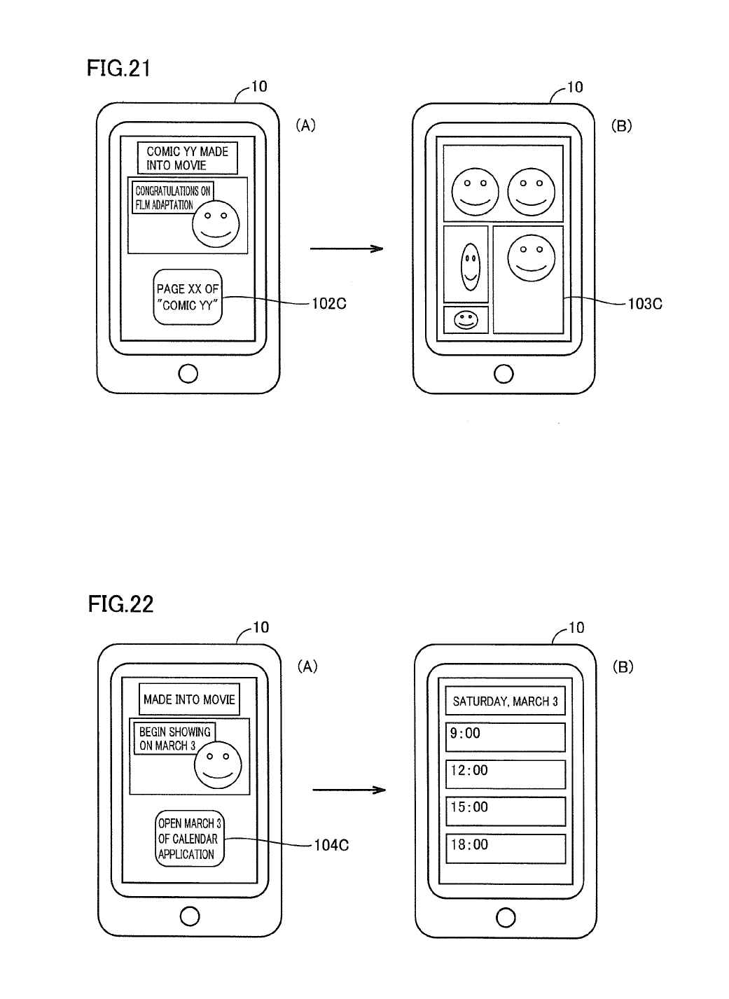

FIG. 21 (A) shows a title image of an electronic book on terminal 10 and an icon 102C which is an operation portion image for jumping to a prescribed page of an electronic book is displayed over the title image. When icon 102C is operated, terminal 10 searches memory portion 12 for data of the prescribed page of the electronic book and reads the data therefrom, and displays an image 103C of the read page data on display portion 13 (see FIG. 21 (B)).

Alternatively, a content of a calendar may be distributed. FIG. 22 (A) shows a title image of a calendar on terminal 10, and an icon 104C which is an operation portion image for jumping to a schedule on a prescribed date (March 3 in the figure) of the calendar is displayed over the title image. When icon 104C is operated, an API command is executed. In accordance with the result of execution, terminal 10 searches for distributed calendar data stored in memory portion 12 based on the prescribed date, reads schedule data on the prescribed date from the calendar data, and displays an image of the read schedule data on display portion 13 (see FIG. 22 (B)).

Though a UI is provided as a displayed image in the embodiment described above, the UI is not limited to an image. Namely, terminal 10 (20) may include an output portion for receiving audio and video data as a UT from a server and outputting the same.

(Other Embodiments)

An information processing method in terminal 10 described above can also be provided as a program. Such a program can be provided as storage medium 17 accompanying a computer. Namely, a program can be recorded in a non-transitory manner in a computer readable recording medium such as a flexible disc, a CD-ROM (Compact Disc Read Only Memory), a ROM, a RAM, and a memory card, and can be provided as a program product. Alternatively, a program can also be provided by downloading through network NT. For example, in the configuration in FIG. 2, the program can be supplied to terminal 10 including CPU 11 which is a processor and having a function as a computer by using storage medium 17 corresponding to a computer readable recording medium. CPU 11 reads a program stored in storage medium 17 through external I/F 16 and executes the same. In addition, terminal 10 can also store a program in a prescribed area of memory portion 12 through downloading via network NT.

Thus, a program product for realizing the method according to the embodiment described above by using a computer is supplied to terminal 10. A program product includes a program itself and a recording medium in which a program is recorded.

(Effects of Embodiments)

According to the embodiments described above, a content distribution service provider can relatively easily restrict a source of issuance of an API command based on a server domain name of the source of issuance, without particularly improving each of terminal 10 executing an API command and terminal 20 controlled by terminal 10 in accordance with execution thereof, in providing its unique UI to which the API command has been allocated.

Determination as to whether or not service originates from malignant content distribution server 40 based on password checking can be completed only in terminal 10 receiving data including an API command, and terminal 20 such as a television should only have a function to accept a direction resulting from execution of an API command from terminal 10, without the need for particular improvement.

In addition, service provided through communication to terminal 20 such as a television in accordance with execution of an API command can be controlled by a service provider side based on specific information such as a server domain name. Therefore, a URL jump destination can also be controlled.

Furthermore, even in a case where a third party illegally obtains key 701 owned by terminal 10 executing an API command, information processing device 30 can relatively easily take measures against unauthorized use of the key by the third party, by rewriting key 701 of terminal 10 through network NT. Thus, execution of an API command distributed only to terminal 10 having valid key 70 can be permitted.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

10, 20 terminal; 30 information processing device; 40 content distribution server; 71, 77 server domain name; 72 password; 76, 732 reproduction stop position; 113 download request unit; 114 reproduction position notification unit; 115 content acknowledgement unit; 116 character string generation unit; 117 checking unit; 118 command execution unit; 120 remote controller unit; 123, 218 content reproduction unit; 124 reproduction position obtaining unit; 313 password generation unit; 316, 416 password notification unit; 417 password request unit; 420 position management unit; 701, 702 key; NT network; and PA communication packet.

1. A communication system, comprising:
a server;
a terminal; and
an information processing device, which communicate with one another through a network,
said server including:
means for receiving from said information processing device, a first password generated from first data indicating a key and server specific information specific to the server by using a predetermined function; and
password transmission means for transmitting said received first password and processing designation information designating processing to said terminal; and
said terminal including:
storage means for storing second data indicating a key matching with the key indicated by said first data obtained from said information processing device;
second password generation means for generating a second password from said second data in said storage means and said server specific information by using said function; and
checking means for checking said first password received from said server and generated said second password against each other, and
said terminal determining whether to perform processing designated by said processing designation information received from said server based on a result of said checking.

2. The communication system according to claim 1, wherein:
said information processing device generates said first password from said first data and said server specific information by using said function and transmits generated said first password to said server; and
said terminal receives said second data from said information processing device.

3. The communication system according to claim 1, wherein:
said terminal further includes an output portion for outputting information and means for receiving from said server, information for accepting a user operation for performing the processing designated by said processing designation information; and
said output portion outputs operation information based on said received information when the processing designated by said processing designation information is performed.

4. The communication system according to claim 3, wherein:
said output portion includes a display portion for displaying an image;
said receiving means receives from said server, image information for displaying an image of an operation portion for accepting the user operation for performing the processing designated by said processing designation information; and
said display portion displays the image of said operation portion based on said received image information when the processing designated by said processing designation information is performed.

5. The communication system according to claim 1, wherein:
said terminal performs the processing designated by said processing designation information when the result of said checking indicates match between said first password and said second password.

6. The communication system according to claim 1, wherein:
the processing designated by said processing designation information includes reproduction control processing for controlling content reproduction means for reproducing and outputting a content.

7. The communication system according to claim 6, wherein:
said terminal further includes control signal transmission means for transmitting a control signal to an electrical device having said content reproduction means; and
said control signal represents a signal for controlling said content reproduction means in accordance with execution of the processing designated by said processing designation information.

8. The communication system according to claim 7, wherein:
said electrical device includes a device communication unit for communication through said network; and
said control signal includes an address of the server for communicating with said server via said device communication unit.

9. The communication system according to claim 6, wherein:
said content reproduction means reproduces a content distributed from said server.

10. The communication system according to claim 9, wherein:
said content indicates time sequence data;
said server further includes reproduction position obtaining means for obtaining positional information indicating a position in said time sequence of data being reproduced at time when said content reproduction means stops reproduction of the content; and
said server distributes the content based on said positional information obtained by said reproduction position obtaining means.

11. The communication system according to claim 8, wherein:
said server includes a first server for transmitting said first password and said processing designation information to said terminal and a second server indicated by said address; and
said server specific information indicates information specific to said second server.

12. The communication system according to claim 1, wherein:
said server specific information is identification information for identifying the server in said network.

13. A terminal in a communication system including a server, said terminal, and an information processing device, which communicate with one another through a network, said server including means for receiving from said information processing device, a first password generated from first data indicating a key and server specific information specific to the server by using a predetermined function and password transmission means for transmitting received said first password and processing designation information designating processing to said terminal, comprising:
storage means for storing second data indicating a key matching with the key indicated by said first data obtained from said information processing device;
second password generation means for generating a second password from said second data in said storage means and said server specific information by using said function; and
checking means for checking said first password received from said server and generated said second password against each other, and
said terminal determining whether to perform processing designated by said processing designation information received from said server based on a result of said checking.

14. A communication method in a communication system including a server, a terminal, and an information processing device, which communicate with one another through a network, comprising the steps of:
in said server,
receiving from said information processing device, a first password generated from first data indicating a key and server specific information specific to the server by using a predetermined function; and
transmitting said received first password and processing designation information designating processing to said terminal; and
in said terminal,
storing second data indicating a key matching with the key indicated by said first data obtained from said information processing device;
generating a second password from said stored second data and said server specific information by using said function;
checking said first password received from said server and generated said second password against each other; and
determining whether to perform processing designated by said processing designation information received from said server based on a result of said checking.

15. A program for causing a processor of a terminal in a communication system including a server, said terminal, and an information processing device, which communicate with one another through a network, to perform a control method,
said server including:
means for receiving from said information processing device, a first password generated from first data indicating a key and server specific information specific to the server by using a predetermined function; and
password transmission means for transmitting received said first password and processing designation information designating processing to said terminal,
said control method including the steps of:
storing in a memory, by storage means of said processor, second data indicating a key matching with the key indicated by said first data obtained from said information processing device;
generating, by second password generation means of said processor, a second password from said second data in said memory and said server specific information by using said function; and
checking, by checking means of said processor, said first password received from said server and generated said second password against each other, and
whether to perform processing designated by said processing designation information received from said server being determined based on a result of said checking.

16. A computer readable recording medium recording the program according to claim 15 in a non-transitory manner.
